(19) United States
(12) Patent Application Publication
(10) Pub. No.: US 2013/0062196 A1
(43) Pub. Date: Mar. 14, 2013

(54) APPARATUS FOR PRODUCING IONIZED WATER

(71) Applicant: Jong-Ho Sin, Seongnam-si (KR)

(72) Inventor: Jong-Ho Sin, Seongnam-si (KR)

(73) Assignee: IONFARMS CO., LTD., Bupyeng-gu, Incheon (KR)

(21) Appl. No.: 13/578,474

(22) PCT Filed: Apr. 6, 2011
(86) PCT No.: PCT/KR2011/002343

§ 371 Date: Aug. 10, 2012

(30) Foreign Application Priority Data
May 17, 2010 (KR) 10-2010-0045881

(51) Int. Cl. C02F 1/461

(52) U.S. Cl. 204/228.6

(57) ABSTRACT

The apparatus capable of producing ionized water may have a simplified structure to prevent water from being lost and also prevent an electrode and ion diaphragm from being damaged. The apparatus may selectively supply alkaline water and acidic water. The apparatus includes an ionization electrolytic cell configured to contact the raw water only with one electrode disposed on one or more inner walls of the ionization electrolytic cell to contact the raw water only with either of the anode and cathode, an ionization water controller controlling the ionization electrode according to the discharge of the ionized water, and a switch applying a signal from a user to the ionization water controller.

### CLAIM OF PRIORITY

This application makes reference to, incorporates the same herein, and claims all benefits accruing under 35 U.S.C. §119 from an application filed in the Korean Intellectual Property Office on 17 May 2010 and there duly assigned Serial No 10-2010-0045881. Furthermore, this application makes reference to, incorporates the same herein, and claims all benefits accruing under 35 U.S.C. §365(c) from a PCT International application entitled APPARATUS FOR PRODUCING ION WATER filed on 6 Apr. 2011 and duly assigned Serial No. PCT/KR2011/002343.

### BACKGROUND OF TUE INVENTION

1. Field of the Invention

The present invention relates to an apparatus for producing ionized water, and in particular, to an apparatus for producing ionized water which includes an ionization electrolysis cell which has a certain volume for the purpose of ionizing raw water supplied thereto.

2. Description of the Related Art

Water is vital to life and exists almost everywhere on the earth. Most of fresh water has substantially equal hydrogen ions (H⁺) and hydroxyl ions (OH⁻). Water becomes acidic water when the concentration of hydrogen ions (H⁺) exceeds that of hydroxyl ions (OH⁻), On the other hand, water becomes alkaline water when the concentration of hydroxyl ions (OH⁻) exceeds that of hydrogen ions (H⁺). Acidic water and alkaline water may be directly obtained from nature. Acidic water and alkaline water may also be produced by man-made apparatus, for example, by ion water apparatus based on electrolysis processes.

Today, acidic water and alkaline water produced by ion water apparatus is widely used. For example, acidic water can be used for beauty and skin care. Human hair and skin are mildly acidic, which allows acidic water to interact with them beneficially. Acidic water has the ability to restore sheen of hair and to promote smoothness and tightness of skin. For another example, because most bacteria cannot live in an acidic environment, acidic water may also be used for cleaning and disinfecting. Alkaline water produced by ion water apparatus is beneficial to human beings, too. For example, drinking alkaline water may help to reduce the overall acidity level of human bodies, making human beings more resistant to disease.

In the present invention, ionized water means either acidic water or alkaline water, or both. Raw water means the water supplied to an ion water apparatus for producing ionized water.

A contemporary apparatus for producing ionized water may be formed with two electrolysis cells separated by an ion partition allowing only ions to pass through, and an electrolysis electrode disposed at each electrolysis cell. The raw water supplied to one of the electrolysis cells can be converted to acidic water and the raw water supplied to the other electrolysis cell can be converted to alkaline water by an electrolysis process.

The contemporary apparatus for producing ionized water is directed to selectively using one of the ionized water, either the alkaline water or acidic water, depending on a user's needs. Because most of the non-selected ionized water is discharged and wasted, the quantity of the raw water that is consumed during the production of ionized water is excessive, Moreover, dissolved solid substances contained in the raw water, such as calcium, magnesium, etc., might attach on the electrodes during the ionization process of the raw water. Adversely, the ion partition of the contemporary apparatus may become clogged and damaged.

### SUMMARY OF THE INVENTION

It is an object of the present invention to provide an apparatus for producing ionized water which may resolve the problems encountered in contemporary art in which a contemporary apparatus for producing ionized water may excessively use raw water, because the produced alkaline water or acidic water is selectively used in dependence upon the user's necessity while most of the non-selected alkaline water or acidic water is discharged and wasted.

It is another object of the present invention to provide an apparatus for producing ionized water to resolve the problems encountered in contemporary art in which a contemporary apparatus may damage the electrode and the ion partition of the apparatus due to the dissolved solid substances contained in raw water.

It is yet another object of the present invention to provide an apparatus for producing ionized water which may include an ionization electrolysis cell which has a certain volume for ionizing raw water supplied thereto. An ionization electrode assembly is provided at one side of the ionization electrolysis cell. Either an anode or a cathode of the ionization electrode assembly is in direct contact with the raw water. An ionization water controller controls the ionization electrode assembly depending on the discharge of the ionized water. A manipulation part receives a user's manual signal that may be applied to the ionization water controller.

Accordingly, the present invention provides an apparatus for producing ionized water using one electrolysis cell, which minimizes the waste of raw water. The present invention also provides an apparatus for producing ionized water with enhanced functionality which may produce ionized water depending on a user's selection.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded assembly view of an embodiment of the present invention;

FIG. 2 is a schematic view illustrating an engagement according to an embodiment of the present invention;

FIG. 3 is a cross-sectional view of an embodiment of the present invention;

FIG. 4 is a cross-sectional view illustrating a construction of all ionization electrode assembly disposed at both sides of an ionization electrolysis cell according to an embodiment of the present invention;

FIG. 5 is a cross-sectional view illustrating a construction of an insulated coating layer formed on a surface of an outer surface of an externally exposed electrode of an ionization electrode assembly according to an embodiment of the present invention;

FIG. 6 is a cross-sectional view illustrating a construction of an ozone degradation stage implemented using an ozone degradation catalyst according to another embodiment of the present invention;

FIG. 7 is a cross-sectional view illustrating a construction of an ozone degradation stage implemented using an active carbon according to another embodiment of the present invention;

FIG. 8 is a cross-sectional view illustrating a construction of an ozone degradation stage implemented using an ultraviolet ray emitter according to another embodiment of the present invention;

FIG. 9 is an oblique view illustrating a construction of an ionization electrolysis cell implemented in a circular plate shape according to an embodiment of the present invention;

FIG. 10 is an oblique view illustrating a construction of an ionization electrolysis cell implemented in a cylindrical shape according to an embodiment of the present invention; and

FIG. 11 is a schematic view of a contemporary apparatus for producing ionized water.

### DETAILED DESCRIPTION OF THE INVENTION

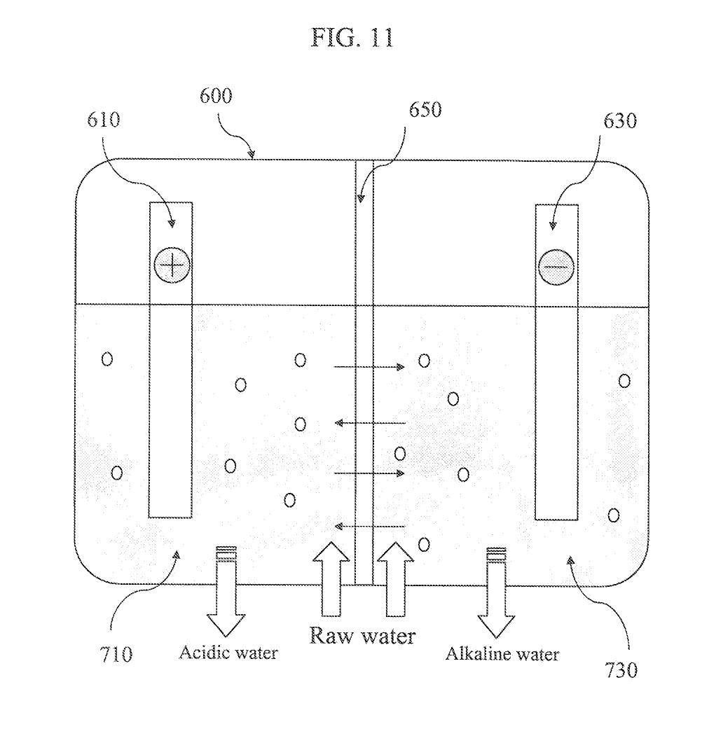

Turning now to the drawings, FIG. 11 shows an embodiment of an apparatus 600 for producing ionized water. The apparatus 600 has two electrolysis cells 710 and 730 separated by an ion partition 650 constructed in accordance with contemporary principles. The ion partition 650 allows only ions to pass through. An anode electrode 610 and a cathode electrode 630 are placed in the electrolysis cells 710 and 730, respectively. The raw water supplied to the electrolysis cell 710 becomes acidic water while the raw water supplied to the electrolysis cell 730 becomes alkaline water, after an electrolysis process has been performed.

The contemporary apparatus 600 for producing ionized water is directed to selectively using one of the ionized water that is either the alkaline water or acidic water, only in dependence upon a user's needs, Because most of the non-selected ionized water is discharged and wasted, the quantity of the raw water that is consumed during the contemporary production of ionized water is excessive.

The preferred embodiments of the present invention will now be described in detail with reference to the accompanying drawings.

The present invention is generally directed to preventing damage to an electrode and an ion partition of an apparatus for producing ionized water that would otherwise be caused by dissolved solid substances contained in raw water. The present invention is also directed to minimizing waste of the raw water during the process of producing ionized water.

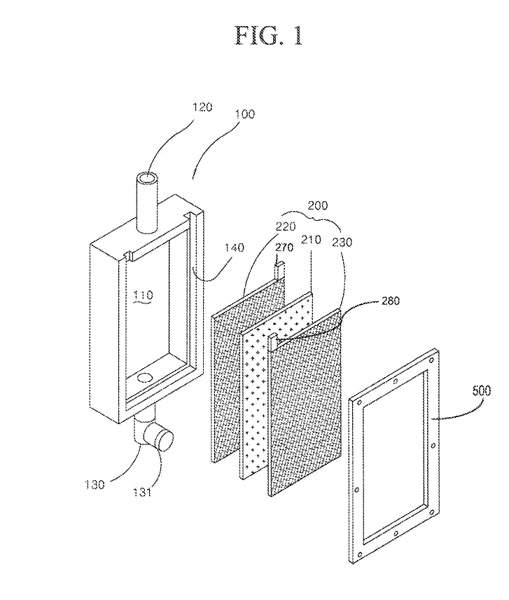

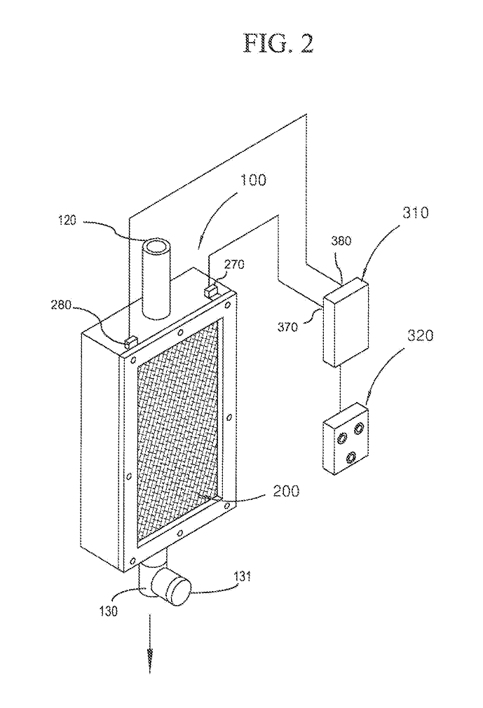

As shown in FIGS. 1 and 2, an apparatus for producing ionized water constructed as an embodiment according to the principles of the present invention may include an ionization electrolysis cell 100 which has a certain volume for the purpose of ionizing raw water supplied thereto. An ionization electrode assembly 200 disposed at one side of the ionization electrolysis cell 100 allows either an anode or a cathode of the ionization electrode assembly 200 to be in direct contact with the raw water. An ionization water controller 310 controls the ionization electrode assembly 200 depending on the selection of the ionized water. A manipulation part 320, such as a manual or automatic switch, receives a user's manual signal that may he applied to the ionization water controller 310.

In addition, the apparatus for producing ionized water may include a mounting frame 500 which affixes the ionization electrode assembly 200 to the ionization electrolysis cell 100.

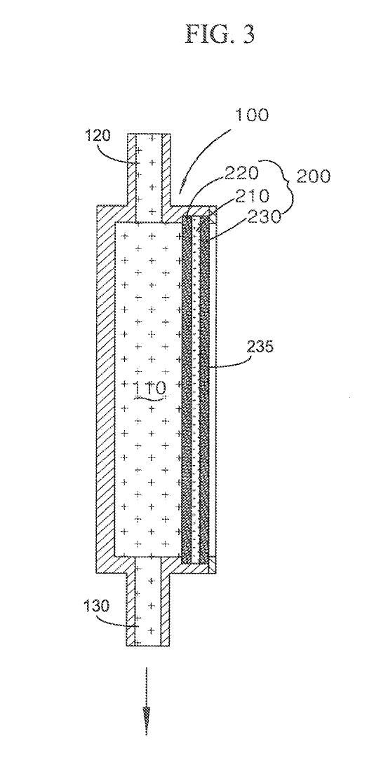

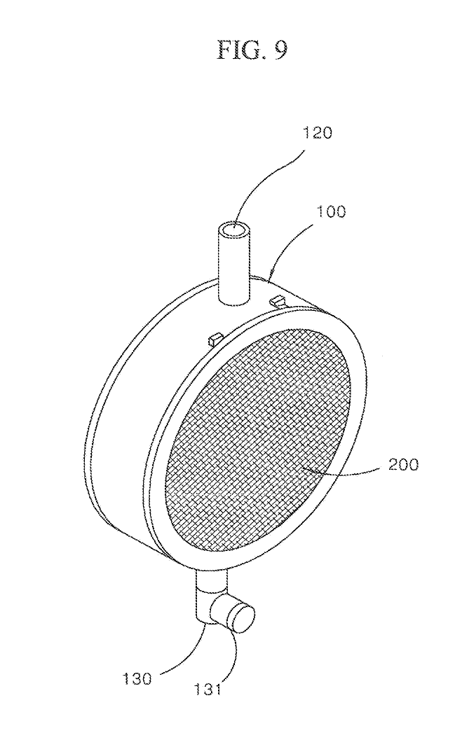

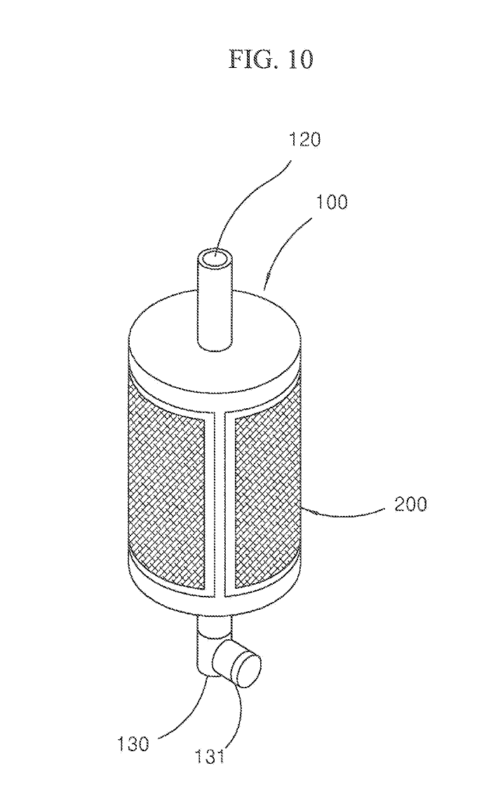

As shown in FIGS. 1 and 3, the ionization electrolysis cell 100 includes an ionization chamber 110 which has a certain volume, A raw water inlet tube 120 is connected to the ionization electrolysis cell 100 for receiving raw water. An ionized water discharge tube 130 is connected to the ionization electrolysis cell 100 at an opposite direction of the raw water inlet tube 120 for discharging ionized water. An electrode installation part 140 in which an ionization electrode assembly 200 is installed is disposed at one side surface of the ionization electrolysis cell 100 in the flowing direction of the raw water from the raw water inlet tube 120 to the ionized water discharge tube 130. The outer surface of the ionization electrode assembly 200 is exposed externally to air. The ionization electrolysis cell 100 may have a rectangular box shape as shown in FIG. 1, a polygonal plate shape, a circular plate shape as shown in FIG. 9, or a cylindrical shape as shown in FIG. 10.

In addition, a discharge valve 131 may be provided at the ionized water discharge tube 130 for controlling the discharge of ionized water. The discharge valve 131 can be either a manual valve or an automatic valve. The discharge valve 131 may be controlled by the ionization water controller 310.

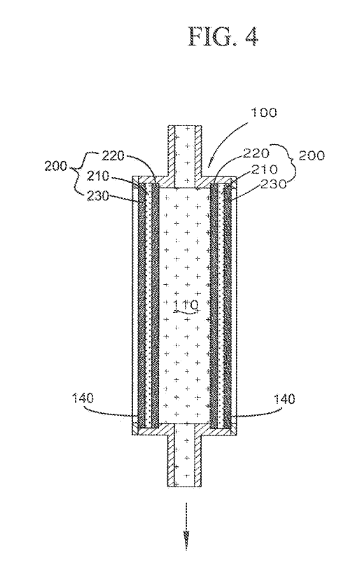

According to another embodiment as shown in FIG. 4, the electrode installation part 140, together with the ionization electrode assembly 200, may be formed at both sides of the ionization chamber 110 to enhance the ionization of raw water.

As shown in FIGS. 1 and 3, the ionization electrode assembly 200 has a raw water contact electrode 220, an externally exposed electrode 230, and an ion partition 210 sandwiched between the raw water contact electrode 220 and the externally exposed electrode 230. The ion partition 210, Which only allows ion substances to pass through, may be formed as either a proton exchange membrane or a polymer electrolyte membrane. The raw water contact electrode 220 may allow ion substances to pass through. One surface of the raw contact electrode 220 on the opposite or interior side of the ion partition 210 may be configured to be in direct contact with the raw water. The externally exposed electrode 230 may allow oxygen and ozone and hydrogen gas generated in the ionization process to pass through. One surface of the externally exposed electrode 230 on the opposite or outer side of the ion partition 210 may be configured to externally expose to air.

As shown in FIGS. 1 and 2, the raw water contact electrode 220 has a raw water contact electrode terminal 270, which is electrically connected to an output 370 of the ionization water controller 310. The externally exposed electrode 230 has an externally exposed electrode terminal 280, which is electrically connected to an output 380 of the ionization water controller 310. Therefore, the ionization water controller 310 may alter polarity of the ionization electrode assembly 200 by regulating a voltage differential between the outputs 370 and 380 in accordance with a manual signal applied to the manipulation part 320. More specifically, the raw water contact electrode 220 may serve as a cathode while the externally exposed electrode 230 may serve as an anode, when the ionization water controller 310 provides a relative low voltage at the output 370 and a relative high voltage at the output 380 in corresponding to a signal to produce alkaline water applied to the manipulation part 320. On the other hand, the raw water contact electrode 220 may serve as an anode while the externally exposed electrode 230 may serve as a cathode, when the ionization water controller 310 provides a relative high voltage at the output 370 and a relative low voltage at the output 380 in corresponding to a signal to produce acidic water applied to the manipulation part 320.

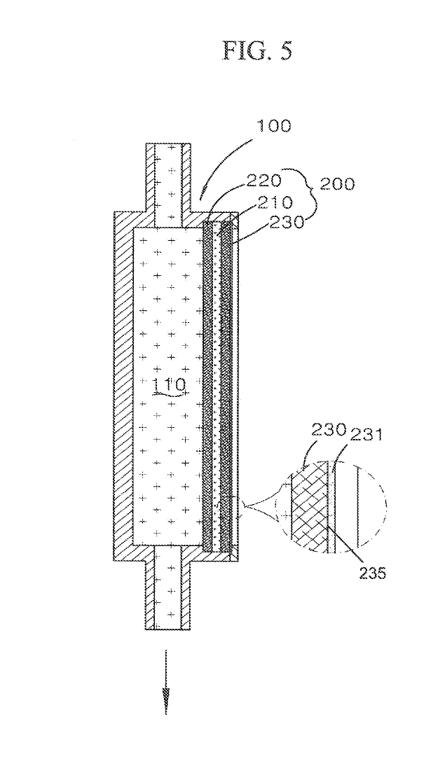

The raw water contact electrode 220 and the externally exposed electrode 230 may be formed either as a net shaped plate or a porous plate. As shown in FIG. 5, an insulated coating layer 231 may be formed at an outer surface of the externally exposed electrode 230, which does not come into contact with the raw water to prevent oxidation and electric leakage.

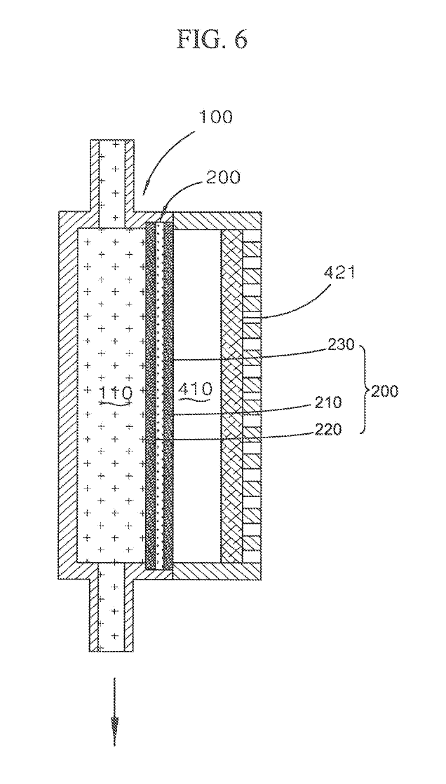

When alkaline water, one type of ionized water, is produced according to the principles of the present invention as shown in FIGS. 6 through 8, an ozone degradation chamber 410 may be disposed at one side of the externally exposed electrode 230 for degrading ozone generated during the ionization with oxygen. The ozone contained in oxygen is discharged via the externally exposed electrode 230. In addition, an ozone degradation stage may also be provided at the ozone degradation chamber 410 in order to more efficiently degrade ozone. A detailed ozone degradation stage will be described as follows.

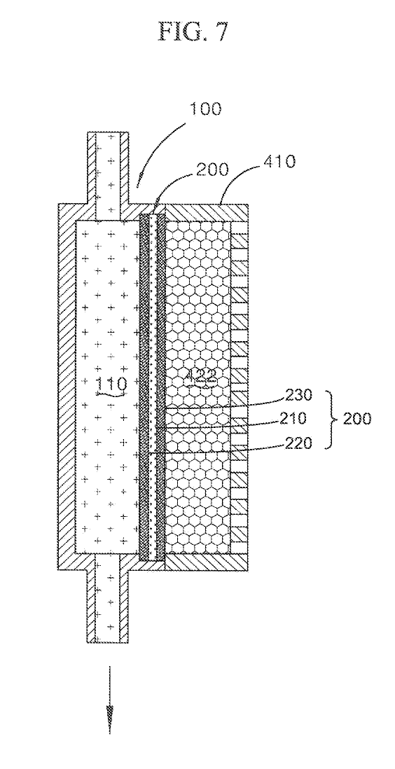

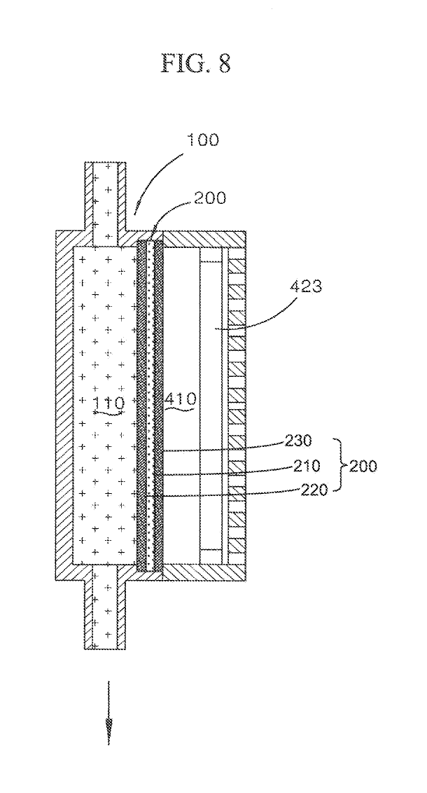

The ozone degradation stage may be selected from an ozone degradation catalyst 421 formed of a manganese oxide and lead compound as shown in FIG. 6, an active carbon 422 which absorbs ozone and naturally degrades ozone as shown in FIG. 7, and an ultraviolet ray emitter 423 which emits ultraviolet rays having a wavelength of approximately 184.9 nm sufficient to degrade ozone as shown in FIG. 8.

The operations of the present invention will now be described in detail.

The apparatus for producing ionized water which may include an ionization electrolysis cell 100 which has a certain volume for the purpose of ionizing raw water supplied thereto. An ionization electrode assembly 200 is provided at one side of the ionization electrolysis cell 100. Either an anode or a cathode of the ionization electrode assembly 200 is in direct contact with the raw water. An ionization water controller 310 controls the ionization electrode assembly 200 depending on the discharge of the ionized water. A manipulation part 320 which receives a user's manual signal applied to the ionization water controller 310.

According to the principles of the present invention, when a user desires to use alkaline water, the user may manually input a corresponding signal representing user's intended use of alkaline water by operating the manipulation part 320. Consequently, the ionization water controller 310 receives the signal and then provides a relatively low output voltage at the output 370 and a relatively high voltage at the output 380. Correspondingly, the raw water contact electrode 220 and the externally exposed electrode 230 of the ionization electrode assembly 200 serve as a cathode electrode and an anode electrode, respectively.

Briefly, when the user manually inputs a signal by operating the manipulation part 320, raw water is electrolysis-processed by means of the ionization electrode assembly 200. A detailed ionization process will be described as follows.

During the ionization process, the oxygen ions contained in the raw water are ionized to negative ions by means of the ionization electrode assembly 200. After passing through the ion partition 210, the oxygen ions arrive at the externally exposed electrode 230, where the oxygen ions emit electrons and become a gaseous phase of oxygen. The generated oxygen gas then escapes into ambient air. Meanwhile the hydrogen ions contained in the raw water take electrons from the raw water contact electrode 220 and change to active hydrogen. And as a result, the raw water changes to alkaline water as the concentration of the hydroxyl ions increases. The produced alkaline water may be discharged via the ionized water discharge tube 130.

According to other embodiments of the present invention, an ozone degradation chamber 410 is implemented at the externally exposed electrode 230 to provide an ozone degradation stage. Thus, the ozone contained in the oxygen emitted to the externally exposed electrode 230 during the production of the alkaline water is efficiently degraded. So the apparatus for producing ionized water according to the embodiments of the present invention may reduce negative effects caused by the ozone and improve safety. The oxygen gas emitted during the process of producing alkaline water according to the present invention contains a small amount of ozone, which may be used for sterilization.

On the other hand, when the user desires to use acidic water, another type of ionized water, according to the present invention, the user may correspondingly manually input a signal representing user's intended use of acidic water to the manipulation part 320. Consequently, the ionization water controller 340 receives the signal and then provides a relatively high output voltage at the output 370 and a relatively low voltage at the output 380. Correspondingly, the raw water contact electrode 220 and the externally exposed electrode 230 of the ionization electrode assembly 200 serve as an anode electrode and a cathode electrode, respectively. As a result, the raw water contact electrode 220 serves as the anode, and hydrogen ions and oxygen are then generated in the raw water. A portion of the hydrogen ions generated by means of the raw water contact electrode 220 pass through the ion partition 210 and move to the externally exposed electrode 230, where the hydrogen ions are converted into a gaseous phase of hydrogen. The generated hydrogen gas then escapes into ambient air. Meanwhile, the raw water with an increased hydrogen ion concentration becomes acidic water and is discharged via the ionized water discharge tube 130. In this case, the acidic water may be used for hygienic purposes such as a face wash or for sterilization and disinfection.

As described above, the ionized water is produced by means of one electrolysis cell in an apparatus for producing ionized water. The apparatus may minimize waste of raw water. The ionized water can be selectively venerated depending on a user's predilections. The apparatus may have enhanced functionality.

The ionization efficiency of the raw water may be improved by providing an ionization electrode assembly at both sides of an ionization electrolysis cell according to another embodiment of the present invention.

The apparatus constructed according to other embodiments of the present invention having ozone degradation stage may prevent negative consequences by degrading a small amount of ozone generated during a production process of alkaline water.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds, are intended Is to be embraced by the appended claims.

1. An apparatus for producing ionized water, comprising:
an ionization electrolysis cell having a certain volume storing ionizing raw water;
an ionization electrode which is provided at one side of the ionization electrolysis cell forming one of an anode or a cathode positioned to have direct contact with the raw water;
an ionization water controller controlling the ionization electrode in dependence upon the discharge of the ionized water; and
a switch applying a user's manual signal to the ionization water controller;
said ionization electrolysis cell comprising:
an ionization chamber formed in a shape selected from among a rectangular box shape, a polygonal plate shape, a circular plate shape and a cylindrical shape providing the certain volume;
a raw water inlet tube disposed to introduce raw water into the ionization chamber;
an ionized water discharge tube disposed to discharge the ionized water from the ionization chamber; and
an electrode installation part disposed to position an ionization electrode with an outer surface of the ionization electrode being externally exposed to flow of the raw water from the raw water inlet tube of the ionization chamber to the ionized water discharge tube, said ionization electrode comprising:
a raw water contact electrode engaged in close contact with one side of an ion partition formed of one of a proton exchange membrane and a polymer electrolyte membrane permitting only ion substances to pass through and coming into contact with the raw water; and
an externally exposed electrode engaged in close contact with the ion partition at an opposite side of the raw water contact electrode and externally exposed to allow oxygen and ozone or hydrogen gas produced during the ionization procedure to pass through.

2. The apparatus of claim 1, wherein said electrode installation part is installed at both sides of said ionization electrolysis cell, thereby enhancing the ionization of raw water.

3. The apparatus of claim 1, wherein said raw water contact electrode and said externally exposed electrode are formed of either a net shaped plate or a porous plate, and an insulated coating layer is formed at an outer surface of the externally exposed electrode not coming into contact with raw water, thereby preventing oxidation and electric leakage.

4. The apparatus of claim 1, wherein an ozone degradation chamber is disposed at the side of the externally exposed electrode, thereby degrading the ozone to oxygen, the ozone being contained in the oxygen discharged via the externally exposed electrode when ionized water is used as alkaline water, and an ozone degradation stage is provided at the ozone degradation chamber.

5. The apparatus of claim 1, wherein said ozone degradation stage is formed of one selected from the group consisting of:
an ozone degradation catalyst formed of either manganese oxide and lead compound;
an active carbon which absorbs ozone and naturally degrades as time passes; and
an ultraviolet ray emitter which emits ozone degradation ultraviolet rays.
